(19) United States
(12) Patent Application Publication
(10) Pub. No.: US 2026/0167010 A1
(43) Pub. Date: Jun. 18, 2026

(54) Electrical Vehicle and Method for Operation thereof

(71) Applicant: Ian Clague, Bournemouth (GB)

(72) Inventor: Ian Clague, Bournemouth (GB)

(21) Appl. No.: 19/074,735

(22) Filed: Mar. 10, 2025

(30) Foreign Application Priority Data
Dec. 13, 2024 (GB) 2418369.1

(51) Int. Cl. B60L 8/00; B60L 50/60; B60L 53/20; B60L 55/00; H05H 15/00

(52) U.S. Cl. CPC B60L 8/003; B60L 50/66; B60L 53/20; B60L 55/00; H05H 15/00

(57) ABSTRACT

There is provided an electrical vehicle including one or more electrical motors, and a power module for storing energy in a battery energy storage module, for generating energy using at least one energy converter module, and for controlling power flows within the electrical vehicle in response to driving commands provided from a user, wherein the power module is configured to control power delivered to and received from the one or more motors. The at least one energy converter module is configured to bifurcate photons into corresponding electrons and positrons, to configure the electrons and positrons to undergo spontaneous mutual acceleration to provide corresponding accelerated electrons and positrons, and to harvest energy of the accelerated electrons and positrons to provide power to operate the electrical vehicle.

### CROSS-REFERENCES TO RELATED APPLICATIONS

This Non-Provisional Patent application claims the benefit of and priority to United Kingdom Patent Application Serial No. GB 2418369.1, filed Dec. 13, 2024, entitled “Electrical Vehicle and Method for Operation thereof,” the entire contents of which is hereby incorporated herein by reference.

### BACKGROUND

The present disclosure relates to electrical road vehicles (EV's) that are configured to be propelled by electrical power. Moreover, the present disclosure relates to methods for using aforesaid electrical vehicles (EV's) for transportation. Furthermore, the present disclosure relates to software products stored on a data carrier, wherein the software products are executable on computing hardware for implementing the aforesaid methods.

Electrical motive power started in year 1827 when a Hungarian priest Ányos Jedlik built a first crude but viable electrical motor; in year 1828, he used it to power a small model car. The first mass-produced electrical vehicles appeared in the USA in the early 1900's. In year 1902, Studebaker Automobile Company entered the automotive business with electrical vehicles, though it also entered the gasoline vehicles market in year 1904. However, with the advent of cheap assembly line cars by Ford Motor Company, the popularity of electrical automobiles declined significantly thereafter.

During the late 20^{th} Century and early 21^{st} Century, the environmental impact of the petroleum-based transportation infrastructure, along with the fear of peak oil, has led to renewed interest in electrical transportation infrastructure. EV's differ from fossil fuel-powered vehicles in that the electricity they consume may be generated from a wide range of sources, including fossil fuels, nuclear power, and renewables such as solar power and wind power, or any combination of those. Recent advancements in battery technology and charging infrastructure have addressed many of the earlier barriers to EV adoption, making electrical vehicles a more viable option for a wider range of consumers.

A contemporary company Tesla® manufactures EV's, for example the Cybertruck® product. In China, many recent EV manufacturers have been established (for example BYD), together with battery manufacture in companies such as CATL.

The aforesaid EV's include an energy storage arrangement, for example implemented as one or more rechargeable batteries; the energy storage arrangement stores energy for propelling the EV's via use of one or more electrical motors. The one or more rechargeable batteries are optionally supplemented with supercapacitors and/or ultracapacitors for enabling the energy storage arrangement to provide high peak power to the one or more electrical motors, for example during high acceleration. The one or more electrical motors are optionally configured to function both for providing propulsion as well as for braking purposes; for example, the one or more electrical motors may function as generators when the EV's are subject to braking, wherein energy generating during braking is fed back to recharge the energy storage arrangement, thereby increasing operating energy efficiency of the EV's.

The one or more rechargeable batteries are beneficially Lithium-based batteries, for example Manganese-Cobalt Lithium batteries, Lithium Iron Phosphate batteries, Sodium Chloride batteries and/or solid-state batteries. When the batteries include Lithium, they may be prone to spontaneous thermal runaway, especially when their battery management system (BMS) is ineffective or malfunctions, as often occurs with severe damage resulting therefrom.

A common problem faced by users of EV's is a lack of battery charging infrastructure. Such a lack may potentially lead to the users suffering “range anxiety”, namely uneasiness about finding functional and appropriately configured battery charging facilities. The lack is even hampering adoption of EV's by the public.

The present disclosure seeks to address shortcoming and problems encountered with known EV's.

### SUMMARY

According to a first aspect, there is provided an electrical vehicle as defined in appended claim 1.

According to a second aspect, there is provided a method for operating the electrical vehicle of the first aspect, wherein the method is defined in appended claim 10.

According to a third aspect, there is provided a software product recorded on a machine-readable data carrier, wherein the software product is executable on computing hardware for implementing the method of the second aspect.

Embodiments of the present disclosure are of advantage in that they include an energy converter that functions to provide power input to the electrical vehicle to assist its operation.

### BRIEF DESCRIPTION OF THE DRAWINGS

Embodiments of the present disclosure will be described with reference to the following diagrams, wherein:

FIG. 1 is an illustration of an electrical vehicle pursuant to the present disclosure;

FIG. 2 is a more detailed schematic illustration of component parts of the electrical vehicle of FIG. 1;

FIG. 3 is an illustration of a method for operating the electrical vehicle of FIG. 2;

FIG. 4A is a schematic plan-view illustration of an energy converter of the present disclosure, wherein the energy converter includes a photon bifurcation region A, a biasing region B, an acceleration region C, and an energy harvesting region D;

FIG. 4B is an alternative implementation of the energy converter of FIG. 4A, wherein the region B and the region C are spatially coincident;

FIG. 5 is an illustration of forces occurring between matter and anti-matter, as reported in the Pei et al. citation; the forces are used in the energy converter of FIGS. 4A, 4B; and

FIG. 6 is an illustration of steps of a method for operating the energy converter of FIGS. 4A, 4B.

### DETAILED DESCRIPTION

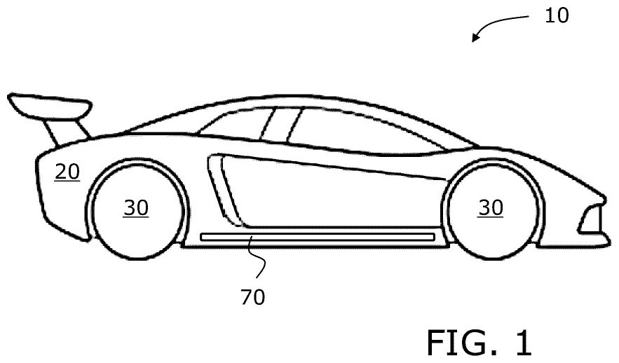

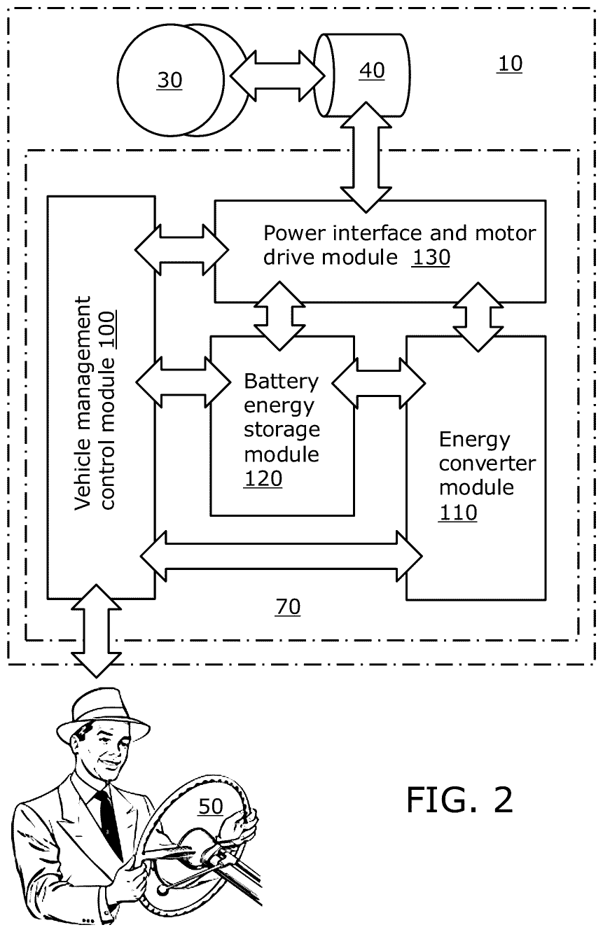

Referring to FIGS. 1 and 2, there is shown an electrical vehicle (EV) of the present disclosure; the electrical vehicle is indicated generally by 10. The electrical vehicle 10 includes a bodywork and chassis 20 provided with wheels 30 that are coupled to one or more electrical motors 40. Optionally, the wheels 30 and their respective motors 40 are implemented as in-wheel motors. Alternatively, optionally, the wheels 30 are coupled to their one or more electrical motors 40 via a mechanical drive train (not shown).

The electrical vehicle 10 further includes a power unit 70 that is conveniently mounted, at least partially, in a lower floor region of the electrical vehicle 10, namely to provide the electrical vehicle 10 with a low centre of gravity, to improve its stability when used on roads and highways. The electrical vehicle 10 is configured to be driven by a user 50; optionally, the electrical vehicle 10 also includes a computer module (not shown) for providing the electrical vehicle 10 with self-driving functionality. Optionally, the user 50 is implemented as a computer-based self-driving apparatus; alternatively the user 50 is implemented as a human being.

The power unit 70 will next be described in greater detail. The power unit 70 includes a vehicle management control unit 100 that is configured to receive driving commands from the user 50, for example steering direction commands, braking commands, acceleration commands, and direction indicating commands; the vehicle management control unit 100 includes computing hardware that is configured to execute one or more software products to enable the vehicle management control unit 100 to function as described herein. Moreover, the power unit 70 includes a battery energy storage module 120, an energy converter module 110 and a power interface and motor drive module 130; in operation, the control unit 100 and the modules 100, 110, 120, 130 are coupled together to deliver and receive energy from the one or more electric motors 40. The energy converter module 110 is implemented using one or more energy chips (“Dirac energy chip”) as described in APPENDIX 1 and APPENDIX 2.

As aforementioned, the control module 100 is configured in use to receive control commands from the user 50. The control module 100 is configured in communication with the modules 110, 120, 130 as illustrated, to control their operation. The energy converter module 110 is coupled to receive or supply energy to the battery energy storage module 120; for example, the battery energy storage module 120 is configured to provide electrical power to the energy converter module 110 to start operation of the energy converter module 110, wherein the energy converter module 110 converts electrical power into photons that are then bifurcated, accelerated and then harvested to provide output electrical power that may be fed back to at least one of the battery energy storage module 120 and the drive module 130 to energize the one or more motors 40. The battery energy module 120 is configured to receive commands from the control module 100, and at least one of: to receive or supply power to the energy converter module 110, to receive or supply power to the drive module 130 to energize the one or more motors 40 or to receive power generated by the one or more motors 40 when regenerative braking is used in operation of the electrical vehicle 10. The drive module 130 is configured to receive commands from the control module 100, and to couple power between the one or more electrical motors 40 and the battery energy storage unit 120; the drive module 130 is also configured to receive energy output from the energy converter module 110 to provide power to operate the one or more motors 40.

Optionally, the battery energy storage module 120 is implemented using one or more batteries; for example, the one or more batteries include at least one of: solid state batteries, Lithium Iron Phosphate batteries, Sodium salt batteries, Manganese Cobalt Lithium batteries, aqueous flow batteries, but not limited thereto. Optionally, the battery energy storage module 120 also includes at least one of: ultracapacitors, supercapacitors; such ultracapacitors and supercapacitors are beneficially included for coping with short-term power surges to and from the one or more motors 40 when in operation.

Beneficially, the one or more electrical motors 40 have a power rating in a range of 10 kW and 100 KW for personal vehicles, and in a range of 10 kW to 1 MW for freight vehicles (for example, trucks, construction vehicles, buses and such like). On account of including the energy converter module 110, the battery energy storage module 120 may have a lower capacity than for a conventional electrical vehicle, therefore reducing the road weight of the electrical vehicle 10. For example, for an automobile implementation, the battery energy storage module 120 may have a capacity of around 10 kWh to 20 kWh, and the energy converter module 110 may be configured to have an energy output of 10 kW. The energy converter module 110 is operable to provide a steady 10 kW output to power the one or more motors 40 when the electrical vehicle 10 is at cruising speed, for overcoming air and road friction resistance and drag. When the electrical vehicle 10 is required to accelerate, both the converter module 110 and the battery energy storage module 120 provide in combination power to the one or more electric motors 40. When the electrical vehicle 10 is required to decelerate or brake, the one or more electrical motors 40 beneficially function as generators to convert kinetic energy of the electrical vehicle 10 into power that is used to recharge the battery energy storage module 120. When the electrical vehicle 10 is parked and therefore stationary, the energy converter module 110 may be used to recharge the battery energy storage module 120. Optionally, the electrical vehicle 10 is provided with a battery charger module (not shown) that allows the electrical vehicle 10 to be plugged into a roadside electrical charger (not shown) for recharging the battery energy storage module 120; beneficially, such roadside electrical charging is achieved via a resonant inductive power coupling, for example as described in a published patent specification “Inductive Power Coupling Systems for Roadways”, WO2013091875 (A2), hereby incorporated by reference.

Operation of the electrical vehicle 10 will next be described in greater detail.

In operation, the energy converter module 110 provides power for steady operation of the electrical vehicle 10, providing power from the energy converter module 110, namely from at least one Dirac powerchip included therein, via the drive module 130 to the one or more electrical motors 40. The energy storage module 120 supplements the energy converter module 110 to cope with surges in power demand by the one or more electrical motors 40, for example when the electrical vehicle 10 is accelerating quickly or the electrical vehicle 10 is being driven up a steep hill. Optionally, as aforementioned, the electrical vehicle 10 has regenerative braking, wherein the one or more electrical motors 40 are configured to provide a braking function by coupling kinetic energy of the electrical vehicle 10 into the battery energy storage module 120.

As aforementioned, the battery energy storage module 120 also provides initial power to start up the converter module 110.

The management control module 100 is coupled to driver-operated controls such as steering wheel, accelerator pedal, brake pedal, to control energy supplied to the one or more electrical motors 40 and optionally energy received from the one or more electrical motors 40.

The various component parts of the electrical vehicle 10 are beneficially implemented in a modular manner as module unit/enclosures housed in at least one of: in a front region of the electrical vehicle 10, in a floor region of the electrical vehicle 10, in a rear region of the electrical vehicle 10.

The electrical vehicle 10 may be implemented with one electric motor 40 per wheel to enable a high degree of vehicle control to be achieved in adverse weather conditions, for example when driving on wet roads or in icy/snowy conditions.

A diminutive form of the electrical vehicle 10 may be implemented as an electrical unicycle, an electrical bicycle, an electrical tricycle, an electrical scooter, an electrical hoverboard, an electrical golfcart, but not limited thereto.

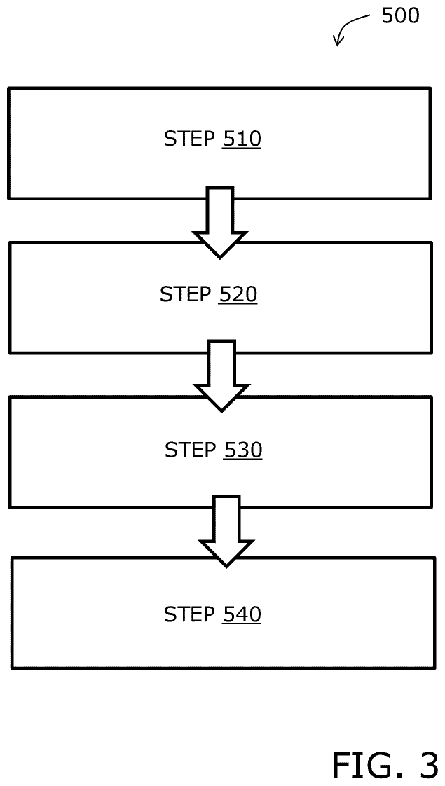

Referring next to FIG. 3, a flow chart is indicated generally by 500. The flow chart 500 includes a series of steps 510, 520, 530 and 540. Moreover, the flow chart 500 relates to a method for operating the electrical vehicle 10.

The method 500 relates to using the aforesaid electrical vehicle 10, wherein the electrical vehicle 10 includes the aforesaid modules 100, 110, 120, 130; the modules 100, 110, 120, 130 include: the control module 100 for controlling operation of the electrical module 10 in response to receiving commands from the user 50, for controlling energy generation occurring within the converter module 110, for controlling energy storage occurring within the battery energy storage module 120, and for controlling energy flow occurring within the electrical vehicle 10, as well as externally into the electrical vehicle 10 and out of the electrical 10 for providing utility power grid support.

The method 500 includes:
the step 510 for configuring the electrical vehicle 10 for power flows to occur therein when in operation;
the step 520 for optionally configuring the electrical vehicle 10 to receive power from a utility power grid to contribute to the power flows;
the step 530 for optionally configuring the electrical vehicle 10 to deliver power to the utility power grid derived from the power flows within the electrical vehicle 10; and
the step 540 for configuring the electrical vehicle 10 to include an energy converter module 110 for delivering power to the electrical vehicle 10, wherein the energy converter module 110 is configured to bifurcate photons into corresponding electrons and positrons, to configure the electrons and positrons to undergo spontaneous mutual acceleration to provide corresponding accelerated electrons and positrons, and to harvest energy of the accelerated electrons and positrons to provide power to operate the electrical vehicle 10.

Various exemplary embodiments are disclosed herein.
Statement 1: An energy converter for converting photons into electrical energy, wherein the energy converter is implemented as an integrated circuit in which the photons propagate in a coherent manner, wherein the energy converter includes a configuration of waveguides and electrodes that are configured to receive the photons, at least partially bifurcate the photons into their respective electrons and positrons, configure the at least partially bifurcated electrons and positrons so that they mutually accelerate to provide accelerated electrons and positrons, and harvest the accelerated electrons and positrons to generate the electrical energy.
Statement 2: An energy converter of Statement 1, wherein the integrated circuit is implemented as a Lithium Niobate photonic integrated circuit or a Lithium-Niobate-On-Insulator photonic integrated circuit.
Statement 3: An energy converter of Statement 1 or 2, wherein the waveguides are fabricated from an optically non-linear material that is configured to exhibit in use a non-linear optical characteristic.
Statement 4: An energy converter of Statement 1, 2 or 3, wherein the waveguides are implemented in an array of mutually parallel elongate waveguides.
Statement 5: An energy converter of Statement 1, 2, 3 or 4, wherein the energy converter includes a biasing and acceleration region (regions B and C) therein, wherein the biasing and acceleration region is configured to apply an electric field to the positrons and electrons to cause them to be configured to mutually accelerate to gain energy, wherein the electric field is orientated with its electric field vector substantially parallel to elongate axes of the waveguides along which the electrons and positrons propagate.
Statement 6: A method for operating an energy converter for converting photons into electrical energy,
wherein the energy converter is implemented as an integrated circuit in which the photons propagate in a coherent manner, wherein the energy converter includes a configuration of waveguides and electrodes that are configured to receive the photons,
wherein the method includes:
   (i) using the energy converter to at least partially bifurcate the photons into their respective electrons and positrons;
   (ii) configuring the at least partially bifurcated electrons and positrons so that they mutually accelerate to provide accelerated electrons and positrons; and
   (iii) harvesting the accelerated electrons and positrons to generate the electrical energy.
Statement 7: A method of Statement 6, wherein the method includes using a biasing and acceleration region to apply an electric field to the positrons and electrons to cause them to be configured to mutually accelerate to gain energy, wherein the electric field is orientated with its electric field vector substantially parallel to elongate axes of the waveguides along which the electrons and positrons propagate.
Statement 8: A photonics module including an energy converter of Statement 1 together with a laser arrangement including one or more lasers configured in use to generate photons for the energy converter to convert to electrical power.

### Appendix 1:

### Energy Converter and Method for Operation Thereof

### TECHNICAL FIELD

The present disclosure provides energy converters that are configured to convert energy from a first form into energy of a second form, for example from photon energy into electrical energy. Moreover, the present disclosure provides methods for using aforesaid energy converters for converting energy from a first form into energy of a second form.

### BACKGROUND

Energy converters are known, for example electrical generators for converting mechanical rotational energy into electrical energy, wind turbines for converting energy of air flows into electrical energy, and photovoltaic panels for converting photons of sunlight into electrical energy.

A problem with photovoltaic panels is that they are inefficient in converting photons in sunlight into electrical power. Moreover, such photovoltaic panels are often bulky and thus unsuitable for incorporating into electrical vehicles.

### SUMMARY

The present disclosure seeks to provide an energy converter for converting photons into electrical energy with improved efficiency relative to known converters.

According to a first aspect, there is provided an energy converter as defined in appended Statement 1. Optionally embodiments of the energy converter are defined in the appended sub-claims to Statement 1.

According to a second aspect, there is provided a method for operating the energy converter of the first aspect, wherein the method is defined in appended Statement 5. Optionally embodiments of the method are defined in the appended sub-claims to Statement 6.

Description of diagrams Embodiments of the present disclosure will be described with reference to the aforementioned appended drawings wherein:

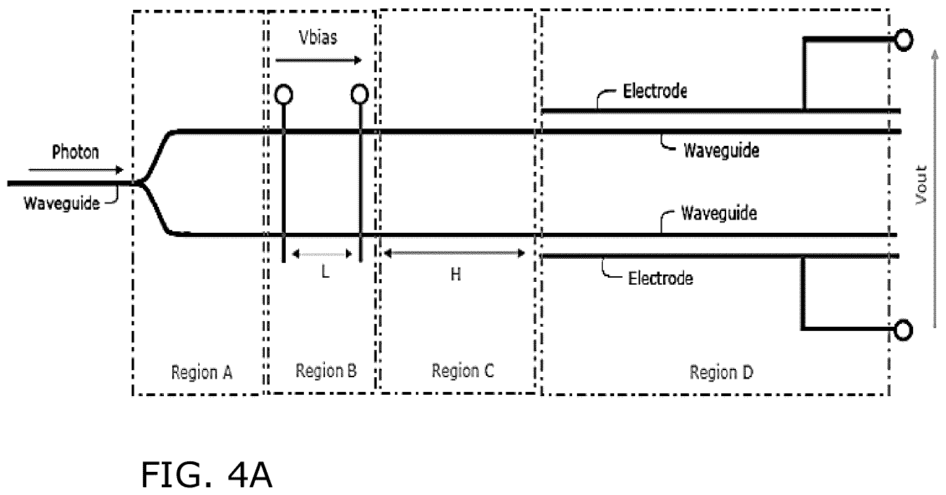

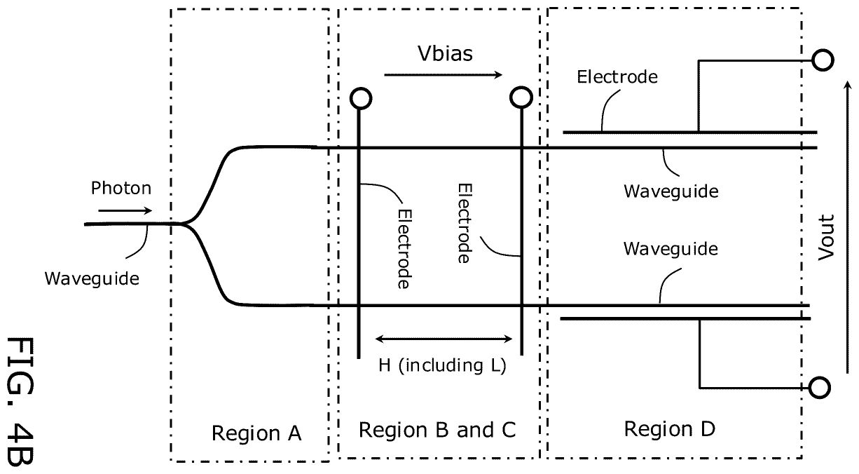

FIG. 4A is a schematic plan-view illustration of an energy converter of the present disclosure, wherein the energy converter includes a photon bifurcation region A, a biasing region B, an acceleration region C, and an energy harvesting region D

FIG. 4B is an alternative implementation of the energy converter of FIG. 4A, wherein the region B and the region C are spatially coincident;

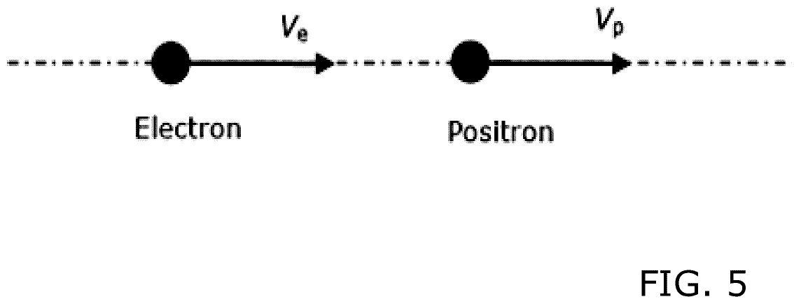

FIG. 5 is an illustration of forces occurring between matter and anti-matter, as reported in the Pei et al. citation; the forces are used in the energy converter of FIGS. 4A, 4B; and

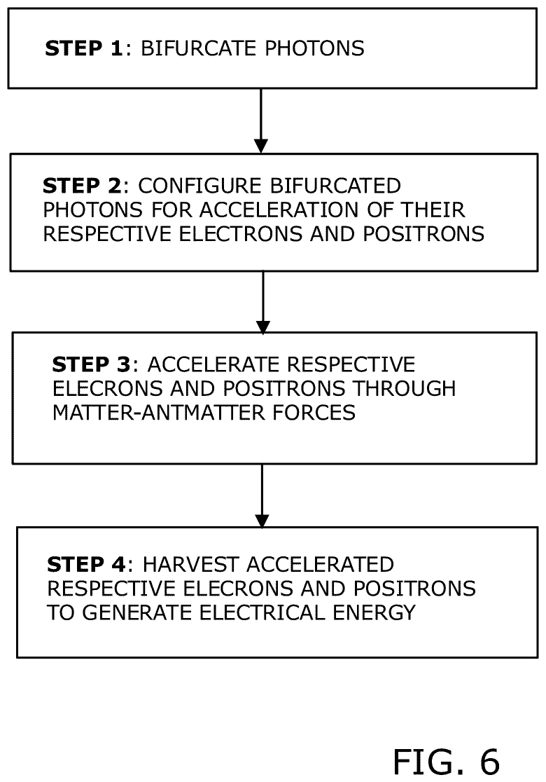

FIG. 6 is an illustration of steps of a method for operating the energy converter of FIGS. 4A, 4B.

### DESCRIPTION OF EMBODIMENTS

An energy converter of the present disclosure is beneficially implemented as an integrated circuit onto a substrate. The integrated circuit includes a combination of optical elements and electrical elements that are formed lithographically onto the substrate. The integrated circuit and the substrate are conveniently implemented as one or more optical waveguides and one or more conductive electrodes formed onto an optically active material, for example Lithium Niobate. Optionally, the integrated circuit and the substrate are implemented as a Lithium-Niobate-on-Insulator (LNOI) device. However, it will be appreciated that other optically non-linear materials, for example Barium-including materials, may be used alternatively to Lithium Niobate or additionally used in combination with Lithium Niobate; for example, the Baium-including materials include at least one of: BaGa4S7 (BGS), BaGa4Se7 (BGSc), BaGa2GeS6 (BGGS), BaGa2GeSe6 (BGGSe), and Ba2Ga8GeS16 (B2GGS).

The aforesaid integrated circuit is conveniently implemented in spatial or function regions, as depicted in FIG. 4A; there are included regions A to region D. In the region A, there is provided an optical waveguide arrangement for receiving photons and bifurcating them into regions of enhanced probability of electrons and enhanced probability of positrons, whilst maintaining coherence of the photons. In the region B, a bias electrode arrangement is provided including at least one electrode, for example two electrodes whose axes are substantially orthogonal to elongate axes of waveguides along which the bifurcated photons propagate when the energy converter is in operation. The bias electrode arrangement is configured to manipulate the bifurcated electrons and positrons into a configuration where the positrons and electrons mutually accelerate as depicted in FIG. 5. In the region C, the electrons and their associated positrons mutually accelerate, thereby gaining energy. In the region D, a harvesting electrode arrangement is used to extract energy from the accelerated electrons and positrons received from the region C; the harvesting electrode arrangement includes at least one electrode, for example two electrodes whose elongate axes are substantially parallel to elongate axes of waveguides along which the bifurcated photons propagate when the energy converter is in operation. An output voltage signal is developed at the harvesting electrode arrangement.

Optionally, the region A includes a beam splitter and a phase adjuster for adjusting parameters of the aforesaid bifurcation of photons to tune operation of the energy converter. Optionally, the optical waveguide arrangement is configured to support propagation of photons by way of Floquet-Bloch modes. Optionally, the waveguide arrangement includes a configuration of a plurality of elongate waveguides whose spatial separation is less than a coherence field of the photons propagating within the energy converter when in operation. Optionally, the energy converter is configured to receive photons from a laser arrangement, for example a laser arrangement configured to output photons within a wavelength range of 2000 nm to 500 nm. Optionally, the laser arrangement is configured to function in a pulsed manner. Optionally, the laser arrangement is implemented as at least one solid state laser. Optionally, the laser arrangement and the energy converter are configured to be spatially collocated into a photonics integrated circuit module. Design details and a manner of operation of the energy converter are described in the APPENDIX 2 that is appended below. The energy converter may be configured to provide less than unity energy gain; alternatively, the energy converter may be configured to provide greater than unity energy gain by breaking symmetry, as described in the Pei et al. citation, likewise in the Wimmer and Regensburger citation “Optical diametric drive acceleration”, likewise in the Meis et al. citation “Quantum Vacuum Gravitational Matter-Antimatter Antigravity” and many other contemporary peer-reviewed research papers.

The aforesaid integrated circuit FIG. 4A may be conveniently implemented with its regions B and C being spatially coincident and overlapping, as illustrated in FIG. 4B. In FIG. 4B, there are included regions A to region D, wherein regions B and C are spatially coincident and overlapping as aforementioned. In the region A in FIG. 4B, there is provided an optical waveguide arrangement for receiving photons and bifurcating them into regions of enhanced probability of electrons and enhanced probability of positrons, whilst maintaining coherence of the photons. In the spatially coincident regions B and C, a bias electrode arrangement is provided including at least one electrode, for example two electrodes whose axes are substantially orthogonal to elongate axes of waveguides along which the bifurcated photons propagate when the energy converter is in operation. The bias electrode arrangement is configured to manipulate the bifurcated electrons and positrons into a configuration where the positrons and electrons mutually accelerate as depicted in FIG. 5. Thus, in the coincident regions C and D, the electrons and their associated positrons mutually accelerate, thereby gaining energy. In the region D, a harvesting electrode arrangement is used to extract energy from the accelerated electrons and positrons received from the coincident regions C and D; the harvesting electrode arrangement includes at least one electrode, for example two electrodes whose elongate axes are substantially parallel to elongate axes of waveguides along which the bifurcated photons propagate when the energy converter is in operation. An output voltage signal is developed at the harvesting electrode arrangement.

Optionally, the region A includes a beam splitter and a phase adjuster for adjusting parameters of the aforesaid bifurcation of photons to tune operation of the energy converter. Optionally, the optical waveguide arrangement is configured to support propagation of photons by way of Floquet-Bloch modes. Optionally, the waveguide arrangement includes a configuration of a plurality of elongate waveguides whose spatial separation is less than a coherence field of the photons propagating within the energy converter when in operation. Optionally, the energy converter is configured to receive photons from a laser arrangement, for example a laser arrangement configured to output photons within a wavelength range of 2000 nm to 500 nm. Optionally, the laser arrangement is configured to function in a pulsed manner. Optionally, the laser arrangement is implemented as at least one solid state laser. Optionally, the laser arrangement and the energy converter are configured to be spatially collocated into a photonics integrated circuit module. Design details and a manner of operation of the energy converter are described in the APPENDIX 2 that is appended below. The energy converter may be configured to provide less than unity energy gain; alternatively, the energy converter may optionally be configured to provide greater than unity energy gain, for example using phenomena as described in the Pei et al. citation, likewise in the Wimmer and Regensburger citation “Optical diametric drive acceleration”, likewise in the Meis et al. citation “Quantum Vacuum Gravitational Matter-Antimatter Antigravity” and many other contemporary peer-reviewed research papers.

A method for using the energy converter to convert photons to electrical energy is illustrated in FIG. 6, wherein the method includes steps of:
(i) STEP 1: receiving photons at the energy converter (for example via a waveguide edge coupler or via a planar grating coupler formed into the energy converter) and bifurcating them spatially in the region A into higher electron probability regions and higher positron probability regions;
(ii) STEP 2: configuring the electrons and positrons of the higher electron probability regions and high positron probability regions for mutual acceleration in the region B;
(iii) STEP 3: configuring the electrons and positrons of region B to accelerate through an acceleration region, namely the region C, as illustrated in FIG. 4A; optionally, regions B and region C are spatially coincident as aforementioned and illustrated in FIG. 4B; and
(iv) STEP 4: harvesting in region D the accelerated electrons and positrons received from region C to generate electrical output power in FIG. 4A, alternatively from the coincident regions B and C in FIG. 4B.

The method is described in greater detail in the APPENDIX 2 below. Optionally, STEPS 1 to 4 may be configured to provide less than unity gain in the energy converter; alternatively, optionally, STEPS 1 to 4 may be configured to provide greater than unity gain in the energy converter.

### Appendix 2

Energy Generation from Photonic Lattices: the “Dirac Drives Supercharger”

1. Overview This Appendix describes an approximate calculation of an electrical power output from an energy converter (referred to as “Dirac Drives Supercharger”). The energy converter is an optical device that is configured to harness repulsive gravitational energy arising therein, and to convert the repulsive gravitational energy into an electrical power output. The energy converter includes a photonic lattice in which a given laser-generated photon at least partially bifurcates into a corresponding electron-positron pair within a coherent spatial envelope of the given photon, wherein the bifurcation is a result of nonlinear optical effects occurring in the photonic lattice. Such “bifurcation” is a known effect that arises when the photonic lattice exhibits an optical dispersion characteristic including a plurality of mutually different dispersion states, for example two mutually different dispersion states. The energy converter includes four regions A to D wherein bifurcation, acceleration and energy harvesting processes occur, as illustrated in FIGS. 1A, 1B; the energy converter includes two mutually-parallel working waveguides that are spaced a small distance apart, wherein the distance is of an approximately similar size to a wavelength of photons propagating along the working waveguides when the energy converter is in use. In the region A, a bifurcation of photons arises due to the a.c. Kerr effect, wherein the photons are effectively converted into corresponding electrons in one of the working waveguides and positrons in the other of the working waveguides. In the regions B and C, these electrons and positrons are subjected to a bias voltage that influences their velocities, resulting in a small spatial separation arising therebetween relative to an elongate axis of the waveguides. This separation allows for an acceleration of the electrons and the positrons, as depicted in FIG. 2, along the working waveguides. In the region D, the accelerated electrons and positrons are Coulombically capacitively coupled to energy harvesting electrodes whereat output electrical energy may be extracted. Calculations of operation of the energy converter implemented using a 10 mm×10 mm optical chip suggest that the energy converter excited by a 10 mW pulsed laser providing photons to the working waveguides may provide 10 Watts of output power at energy harvesting electrodes in the region D, representing a significant energy gain. This Appendix describes potentially even greater output power being feasible using the energy converter through optimization of design parameters of the energy converter, and the use of additional working waveguides when implementing the energy converter. The energy converter utilizes optical and capacitive coupling phenomena that known in the technical art, wherein the phenomena have been reported in many contemporary research papers and therefore constitute known laws of physics.

2. Introduction Photons are traditionally understood to be elementary particles of light. The hypothesis of technology used in the energy converter is routed in the concept of photons being more accurately described as composite (couplet) particles consisting of electron-positron pairs. This hypothesis, supported by experimental evidence previously discussed in Ian Clague's paper [ref. 1], provides a foundation for the energy converter.

As aforementioned, the energy converter is a device that operates by inducing a bifurcation of photons within a nonlinear optical lattice, resulting in the photons being at least partially separated into corresponding electrons and positrons. The electrons and positrons are then manipulated through the aforesaid regions A to C of the device to generate output electrical energy in the region D. Such a process arising within the energy converter involves using a series of stages, wherein each stage contributes to an overall energy output from the energy converter, significantly amplified through exploiting repulsive gravitational forces and precise control of particle dynamics.

3. Motivation via Pei et al. experiments A concept of optical diametric drive acceleration, which underpins operation of the aforesaid energy converter, draws inspiration from experiments conducted by Pei et al, and presented in years 2019 [ref. 2] and 2020 [ref. 3]. Aforesaid experiments demonstrated that a single Gaussian-like light beam could spontaneously self-bend due to nonlinear optical effects occurring within a uniform photonic lattice, leading to the beam's separation into two components experiencing opposite types of diffraction, namely normal and anomalous. Such a separation resulted in a self-accelerating behaviour analogous to an interaction between positive and negative mass objects, thereby effectively breaking conventionally accepted action-reaction symmetry. Pei et al. validated this self-bending phenomenon experimentally using a one-dimensional photonic lattice created in a Lithium Niobate crystal, demonstrating a clear bending shift in a photon beam's position due to non-linear effects.

Embodiments of the present disclosure have been produced by way of a university collaboration, particularly with their Nanofabrication Centre, where necessary Lithium Niobate waveguide arrays have been fabricated. The collaboration has resulted in, for example, successful separation of negative and positive mass beams within a waveguide array chip, namely demonstrating spontaneous self-acceleration of positive mass (electrons) and negative mass (positrons) that were observed in the Pei et al. experiments.

### 4. Photon Propagation and Energy Conversion Regions

In the energy converter, photons are manipulated through the regions A to D to enable the converter to perform its function. These regions A to D are illustrated in FIGS. 1A, 1B, wherein each region serves a distinct corresponding purpose to facilitate a conversion of photon energy into usable electrical power. In the region A, incoming photons are at least partially coherently split into electron-positron pairs within an optically nonlinear medium (for example Lithium Niobate). As the electron-positron pairs propagate through the subsequent regions B to C, their interactions are guided by electric fields applied to the working waveguides, and eventually leading to energy harvesting in the region D.

### 4.1 Region A:

Photons from a laser, such as a compact 1500 nm wavelength solid-state laser, propagate along an entrance waveguide until they reach a waveguide splitter, whereat the entrance waveguide bifurcates into aforesaid two mutually-parallel elongate working waveguides. The region A is constructed from an optically nonlinear material such as Lithium Niobate (for example Lithium-Niobate-On-Insulator (LNOI, TFLN)) which exhibits the a.c. Kerr effect, namely a phenomenon where a refractive index of a material changes in response to an intensity of light (i.e. photon electric field strength) passing therethrough, thereby creating a nonlinear interaction. In this region A, the photons are at least partially coherently split into corresponding electron-positron pairs, with one working waveguide having a higher probability of electrons and the other working waveguide having a higher probability of positrons, within a spatial envelope of the photons. Beneficially, the two working waveguides are spaced less than a wavelength of the photons apart, placing them within a spatial coherence envelope of the photons. This coherence ensures that the resulting electron-positron pairs are able to propagate along their respective elongate working waveguides without the positrons annihilating with surrounding matter. As the photons bifurcate, their velocity decreases, converting part of their energy into the kinetic energy of their corresponding electrons, mutatis mutandis into kinetic energy of their corresponding positrons. For optimal efficiency, the region A supports the propagation of Floquet-Bloch optical modes, which are special types of wave propagation that occur in periodically structure materials, enhancing the control over the photons' behaviour.

### 4.2 Region B:

In the region B, two elongate biasing electrodes are positioned with their elongate axes orthogonal to the elongate axes of the two elongate working waveguides, as shown in FIGS. 1A, 1B. These biasing electrodes transverse the working waveguides and, when activated, are biased by applying a suitable bias voltage V_{bias} thereto. This bias voltage V_{bias} generates an electric field aligned along the elongate axes of the elongate working waveguides. The primary function of the bias voltage V_{bias} is to control the movement of the electrons and positrons, namely to decelerate the electrons and accelerate the positrons, or vice versa. This deceleration and acceleration results in a small spatial separation arising between an electron and a positron of a given photon, allowing for interactions therebetween. Specifically, the electron is attracted to the positron through Coulombic forces, whereas the positron is repelled from the electron by strong gravitational forces, as depicted in FIG. 2. These interactions set the stage for further acceleration in the region C, where the electrons and positrons gain energy. As with the region A, the region B is designed to support the propagation of Floquet-Bloch optical modes, which enhance the control and efficiency of operation of the energy converter device.

### 4.3 Region C:

In the region C, interacting pairs of electrons and positrons accelerate along the elongate working electrodes, gaining energy though a unique mechanism that exploits asymmetry in Newton's Third Law of Motion. This asymmetry arises due to the negative mass of the positrons, which creates a situation where a reaction force does not counterbalance an action in a usual manner. As a result, the electrons and positrons are able to accelerate more effectively. Since the electrons and positrons have already been bifurcated, their speed remains below the speed of light in a vacuum, allowing for controlled energy gain. As is the previous regions A to B, the region C is designed to support propagation of Floquet-Bloch optical modes, which enhances overall efficiency of the energy converter.

### 4.4 Region D:

The region D serves as an energy harvesting zone of the energy converter. In this region D, elongate energy harvesting electrodes (namely “energy generating electrodes”) are positioned parallel to the elongate working waveguides, as depicted schematically in FIGS. 1A, 1B. These energy harvesting electrodes are strategically placed within the coherence envelope of the photons propagating along the working waveguides, ensuring that the electrons and positrons propagating along the working waveguides may effectively couple (namely, via capacitive Coulombic coupling) to their respective energy harvesting electrodes. As these electrons and positrons interact with the energy harvesting electrodes, a voltage Vₒᵤₜ is generated, which, along with the associated current flow, constitutes the power output of the energy converter. As aforementioned, beneficially, the laser is operated in pulsed mode, such that the output voltage Vₒᵤₜ at the energy harvesting electrodes is an a.c. pulsed signal that may be rectified via diodes to generate a d.c. power output from the energy converter. Optionally, a pulse repetition frequency of the laser may be varied to control a magnitude of the voltage Vₒᵤₜ at the energy harvesting electrodes. Optionally, the laser is operated in a burst pulse mode, with a pulse repetition frequency f₁ and a burst repetition frequency f₂, wherein f₂<f₁. Optionally, the output voltage Vₒᵤₜ may be fed via a resonant circuit tuned to the frequency f₁, wherein an output of the resonant circuit is rectified to generate the corresponding d.c. output power. The frequency f₂ may be beneficially adjusted to control a magnitude of the d.c. output power.

Using the resonant circuit enables stray parasitic capacitance (for example, arising from wire bonding pads of the integrated circuit) of the energy harvesting electrodes to have less attenuating effect on an operating efficiency of the energy converter. As with the previous regions A to C, the region D is designed to support the propagation of Floquet-Bloch optical modes, optimizing the efficiency of energy conversion achievable in the energy converter.

### 5. Implementation Details

Implementation of the energy converter requires careful consideration of several practical factors to optimize its operating performance. As aforesaid, the laser is beneficially operated in pulsed mode, as the effectiveness of the photon bifurcation, driven by the a.c. Kerr effect, is proportional to the magnitude of the electric field vector of the photons. The pulse repetition frequency of the laser may be conveniently adjusted to control the power output Vₒᵤₜ from the energy converter.

Power required to generate the bias voltage V_{bias} may be beneficially derived from the output Vₒᵤₜ, as may be the power required to energize the laser. Although only two elongate working waveguides are considered above, there may optionally be included an array of multiple waveguides, for enhancing the energy converter's functionality. Beneficially, the energy converter, its laser and power-processing electronic components for processing the output Vₒᵤₜ may be spatially collocated into a hybrid optical module assembly; such an implementation opens up possibilities for the incorporation of the module assembly into various electronic devices, such as mobile telephones, to provide operating power thereto.

Optionally, positioning the energy converter, when implemented as an integrated circuit chip, within a magnetic field, with field lines orthogonal to a principal surface plane of the chip, further enhances the bifurcation of photons into their respective electrons and positrons in the region A. This magnetic field beneficially also enhances energy harvesting performance in the region D. Optionally, the chip may be mounted onto a major face of a slab Neodymium magnet that is magnetically polarized in an orientation, such that a North pole of the magnet is aligned with one major face of the slab, and a South pole of the magnet is aligned with the other opposite major face of the slab, wherein these two major faces of the magnet are substantially parallel to each other.

### 6. Calculation

Initial calculations for the energy converter, as illustrated in FIGS. 1A, 1B, suggest an energy gain of ×1,000 times, potentially up to ×10,000 times with optimized parameters. For the energy converter implemented as a 10 mm×10 mm chip excited by a 10 mW solid-state laser, an output power of 10 Watts is theoretically possible, assuming that there are no coupling losses and that lossless electron-positron propagation occurs within the energy converter when in use. More conservative estimates predict a practical output of 3 to 9 Watts output power at Vₒᵤₜ, still representing a substantial energy gain. The regions B and C may be spatially combined to allow for simultaneous acceleration and energy gain within the electric field generated by V_{bias}, further optimizing the design of the chip of the energy converter.

The calculation outlined below will next be presented. Below are the constants used for reference.

| Symbol | Quantity | Value | |
|---|---|---|---|
| c | Speed of light in vacuum | 3 × 10⁸ | m/s |
| h | Planck's constant | 6.626070 × 10⁻³⁴ | Joule Hz |
| λ | Wavelength of light used for photons | 1500 nm (standard telecoms components) | |
| ϵ₀ | Permittivity of free space | 8.854187 × 10⁻¹² | F/m |
| m | Rest mass of electron | 9.198 × 10⁻³¹ | kg |
| G_{N} | Newtonian gravitational force | 6.674 × 10⁻¹¹ | m³/(kg · s²) |
| e | Charge on electron | 1.602 × 10⁻¹⁹ | Coulombs |

| | | |
|---|---|---|
| L | Distance | Distance in Region B (see FIG. 1) |
| H | Distance | Distance in Region C (see FIG. 1) |

The energy of a given photon entering into the region A, denoted by E₁, is defined as

$${E}_{1} = hf \qquad Eq . APP1$$

$${E}_{1} = \frac{h c}{λ}$$

where c is the speed of light in a vacuum, h is Plank's constant, and [symbol] is the photon wavelength. The kinetic energy of an electron or positron, in the non-relativistic approximation, is given by

$${E}_{2} = \frac{1}{2} {mv}^{2} . \qquad Eq . APP2$$

The Coulombic forces acting on two charges Q₁ and Q₂ are described by

$$\begin{matrix}{F}_{C} = \frac{{Q}_{1} {Q}_{2}}{4 π {ϵ}_{0} {r}^{2}} \\ = \frac{{e}^{2}}{4 π {ϵ}_{0} {r}^{2}}\end{matrix} \qquad Eq . APP3$$

where r is the distance between the two charges, such as between an electron and its corresponding positron. The gravitational force generated between two masses M₁ and M₂, according to Newton's Law pertaining to masses of at least macroscopic size, is expressed as

$${F}_{G} = \frac{{G}_{N} {M}_{1} {M}_{2}}{{r}^{2}} . \qquad Eq . APP4$$

When considering an electron and a positron separated by a distance r outside their mutual coherence envelope, Eq. APP4 simplifies to

$${F}_{G} = \frac{{G}_{N} {m}^{2}}{{r}^{2}} \qquad Eq . APP5$$

However, at the quantum scale, when r falls within the spatial coherence range of a photon including an electron coupled to a positron, Clague in [ref. 1] has theoretically shown that G_{N} is not applicable. Instead, a strong gravitational force Gₛ=2hc/m² is experienced, modifying Eq. APP5 to Eq. APP6, namely

$${F}_{G} = \frac{{G}_{S} {m}^{2}}{{r}^{2}} . \qquad Eq . APP6$$

### Stage 1:

As a photon enters the region A, it travels at the speed of light, c. Within the region A, it is hypothesized, simplifying the calculations, that the photon completely bifurcates into an electron and a positron within its coherence envelope. This bifurcation is a result of nonlinear optical effects occurring within the materials used to fabricate the region A; such bifurcation is described in Wimmer et al. research paper [ref. 4], for example, relying on there being two dispersion states present in the regions A to D. As an approximation, the energy of the given photon (from Eq. APP1 and Eq. APP3) is equally divided between the kinetic energies of the electron and positron

$$\frac{1}{2} {mV}^{2} = \frac{hc}{2 λ} {V}^{2} = \frac{hc}{m λ} V = \sqrt{\frac{hc}{m λ}} .$$

As the photon bifurcates, the resulting electron and positron become more distinct, causing the photon to decelerate, consistent with Snell's Law (where the velocity of a photon in an optical glass material is slower than in a vacuum). In the energy converter, telecom components are beneficially utilized for cost-effectiveness, with the wavelength/typically set to approximately 1500 nm.

### Stage 2:

In the region B, following the bifurcation caused by the a.c. Kerr effect in the region A, the electron and positron of the given photon are individually influenced by an electric field generated by the applied bias voltage, V_{bias}. Velocities of the electron and positron may be expressed as:

$${V}_{e} = \sqrt{( \frac{hc}{m λ} ) + \frac{{eV}_{bias}}{m}} , \qquad Eq . APP7$$

$${V}_{p} = \sqrt{( \frac{hc}{m λ} ) - \frac{{eV}_{bias}}{m}} , \qquad Eq . APP8$$

where Vₑ is the velocity of the electron, and Vₚ is the velocity of the positron, both within the spatial coherence field of their corresponding photon.

The bias voltage V_{bias} slightly accelerates the positron and decelerates the electron, leading to a small spatial separation r between them relative to the elongate axes of the elongate working waveguides, as illustrated in FIGS. 1A, 1B. To a first approximation, Vₑ≈Vₚ with a slight difference due to the influence of V_{bias}. The axial separation r (namely, difference in position) between the electron and positron may be derived over a given distance L along the working waveguide. If the velocities in Eqs. APP7 and APP8 are considered, the difference between them, DV=Vₑ-Vₚ, may be approximated for small V_{bias} using a first-order Taylor expansion. For convenience, let V₀=hc/ml and use the fact that

$${( 1 + x )}^{n} \approx 1 + n x + \frac{n ( n - 1 )}{2 !} + …$$

Next, rewriting Eqs. APP7 and APP8 in the form of (1+x)ⁿ, there is obtained

$$\begin{matrix}{V}_{e} = {( {V}_{0}^{2} + \frac{{eV}_{bias}}{m} )}^{\frac{1}{2}} \\ = {V}_{0} {( 1 + \frac{{eV}_{bias}}{{mV}_{0}^{2}} )}^{\frac{1}{2}} \\ = {V}_{0} {( 1 + \frac{1}{2} \frac{{eV}_{bias}}{{mV}_{0}^{2}} )}^{\frac{1}{2}} \\ = {V}_{0} {( 1 + \frac{1}{2} \frac{{eV}_{bias}}{{mV}_{0}^{2}} )}^{\frac{1}{2}}\end{matrix}$$

$$\begin{matrix}{V}_{p} = {( {V}_{0}^{2} - \frac{{eV}_{bias}}{m} )}^{\frac{1}{2}} \\ = {V}_{0} {( 1 + ( - \frac{{eV}_{bias}}{{mV}_{0}^{2}} ) )}^{\frac{1}{2}} \\ = {V}_{0} {( 1 + \frac{1}{2} ( - \frac{{eV}_{bias}}{{mV}_{0}^{2}} ) )}^{\frac{1}{2}} \\ = {V}_{0} {( 1 - \frac{1}{2} \frac{{eV}_{bias}}{{mV}_{0}^{2}} )}^{\frac{1}{2}}\end{matrix}$$

where n=½ and x is taken to be either

$$\frac{{eV}_{bias}}{{mV}_{0}^{2}} or - \frac{{eV}_{bias}}{{mV}_{0}^{2}} .$$

Then DV becomes

$$\begin{matrix}Δ V = {V}_{e} - {V}_{p} \\ = {V}_{0} {( 1 + \frac{1}{2} \frac{{eV}_{bias}}{{mV}_{0}^{2}} )}^{\frac{1}{2}} - {V}_{0} {( 1 - \frac{1}{2} \frac{{eV}_{bias}}{{mV}_{0}^{2}} )}^{\frac{1}{2}} \\ = \frac{1}{2} \frac{{eV}_{bias}}{{mV}_{0}} + \frac{1}{2} \frac{{eV}_{bias}}{{mV}_{0}} \\ = \frac{{eV}_{bias}}{{mV}_{0}} .\end{matrix}$$

As the electron and positron travel along the working waveguides, this velocity difference DV leads to a separation over a distance L, namely the length of the region B where the bias voltage V_{bias} is applied. The spatial separation r between the electron and positron may be calculated as

$$r = Δ V t , \qquad Eq . APP9$$

where t is the time it takes for the electron and positron to travel the distance L and is given by t=L/V₀. Hence r becomes

$$\begin{matrix}r = Δ V t \\ = \frac{{eV}_{bias}}{{mV}_{0}} \frac{L}{{V}_{0}} \\ = \frac{{eV}_{bias} L}{{mV}_{0}^{2}} \\ = \frac{{eV}_{bias} L}{m} \frac{m λ}{hc} \\ = \frac{{eV}_{bias} L λ}{hc}\end{matrix}$$

where r must be less than the spatial coherence field of the photon. If there is considered the following example with the numerical values for V_{bias}=1 mV, L=1 mm and l=1500 nm, then r≈1.2 mm. This calculation confirms that r=10⁻⁶ metres lies within the spatial coherence field of a photon with a wavelength of 1=1500 nm.

### Stage 3:

In the region C, the bifurcated electrons and positrons undergo acceleration due to gravitational interaction. The force acting on the electron and positron, defined by the strong gravitations constant Gₛ, causes acceleration according to

$${F}_{G} = m a$$

where “a” is the acceleration of the electron and positron, and FG is the gravitational force but is calculated using the strong gravitational constant Gₛ.

When the force FG acts over a distance H, namely the length of the region C, the work W done is approximated by

$$\begin{matrix}W = {F}_{S} H \\ = \frac{{G}_{s} {m}^{2}}{{r}^{2}} H \\ = ( \frac{2 ℏ c}{{m}^{2}} ) \frac{{m}^{2}}{{r}^{2}} H \\ = \frac{2 H ℏ c}{{r}^{2}} .\end{matrix}$$

Using the data from the energy converter device in FIGS. 1A, 1B, and assuming H=3.025 L, the energy gained per photon is calculated to be approximately 1.326×10⁻¹⁶ Joules per photon. The number of photons, denoted by N, in the laser beam injected into the region A may be determined by

$${P}_{beam} = N {E}_{1}$$

$${P}_{beam} = N ( \frac{hc}{λ} )$$

$$N = \frac{{P}_{beam} λ}{hc}$$

where P_{beam} is the photon power of the laser beam injected into the region A. For a 10 mW laser beam, with l=1500 nm, the number of photons Nis calculated to be 7.546×10¹⁶ photons per second. Thus, the approximate power output Pout available at the harvesting electrodes Vₒᵤₜ in the region D is

$$\begin{matrix}{P}_{out} = NW \\ = 10 Watts .\end{matrix}$$

This calculation suggests a power gain of 1,000 times. By adjusting V_{bias} and the distances L and H, power gains in the order of 10,000 times are theoretically possible. Given that 10 Watts might be excessive for a small waveguide structure, an array of waveguides, of a type as shown in FIG. 1, may be required to optimize a performance the energy converter.

### 7. Energy Converter Optimization

While the theoretical calculations suggest substantial gains from the energy converter, practical implementation of the energy converter requires careful consideration of real-world factors. The efficiency of the energy converter is influenced by the precision of the photon bifurcation, the stability of the bias voltage V_{bias}, and the quality of the materials used (for example, waveguide sidewall smoothness). In particular, minimizing losses due to imperfect bifurcation and ensuring coherence of photons within the energy converter are critical to achieving the estimated energy gains.

The operating performance of the energy converter may be significantly enhanced by optimizing several key parameters:
(i) number of electrons per second (V_{bias}): increasing V_{bias} may control the number of electrons that can be injected into the working waveguides, directly affecting the output power at Vₒᵤₜ. Additionally, effective retention of positrons ensures that a larger fraction of them contribute to energy generation, thereby optimizing the overall operating efficiency of the energy converter;
(ii) positron retention and acceleration (V_{bias}): the bias voltage V_{bias} accelerates electrons and retards positrons, alternatively accelerates positrons and retards electrons, thereby controlling their separation r;
(iii) length of the acceleration zone (region C, dimensions H and L): the distance over which electrons and positrons are accelerated, wherein the relationship between them directly influences the work done on each electron-positron pair and therefore the energy generated in the region D;
(iv) proximity to positrons (separation distance, r): minimizing the separation distance r between electrons and positrons increases an interaction strength therebetween and hence energy gain achievable within the energy converter; and
(v) number of positrons (laser power): higher laser power increases the number of positrons present within the working waveguides, which in turn increase the potential output power from the region D.

### 8. Conclusion

The energy converter, with an energy gain multiplier of 1,000 times, represents a ground-breaking approach to energy generation from photonic lattices. By optimizing key parameters such as the bias voltage (V_{bias}), acceleration zone length (region C) and laser beam power, further enhancements may be made to the energy converter's performance, paving the way for its integration into a wide range of electronic devices to provide operating energy thereto.

### REFERENCES

[ref. 1]: Clague, I. (2022). “Examination of the electromagnetic force and gravity through the composite (couplet) photon”, Advanced Studies in Theoretical Physics 16 (2): pp 41-66.
[ref. 2]: Pei, Yumiao; Hu, Yi; Zhang, Ping; Zhang, Chunmei; Lou, Cibo; E. Rüter, Christian; Kip, Detlef; Christodoulides, Demetrios; Chen, Zhigang; Xu, Jingjun; (2019). “Coherent propulsion with negative-mass fields in a photonic lattice”, Optics Letters 44 (24): pp 5949-5952.
[ref. 3]: Pei, Y.; Wang, Z., Hu, Y., Lou, C., Chen, Z., Xu, J. (2020). “Spontaneous diametric-drive acceleration initiated by a single beam in a photonic lattice”. Optics Letters 45 (11): pp 3175-3178.
5 [ref. 4]: Wimmer, Martin; Regensburger, Alois; Bersch, Christoph; Min, Mohammad-Ali; Batz, Sascha; Onishchukov, Georgy; Christodoulides, Demetrios N.; Peschel, Ulf (2013). “Optical diametric drive acceleration through action-reaction symmetry breaking”. Nature Physics, Letters DOI 10.138 Oct. 2013; pp 781-784.

1. An electrical vehicle including one or more electrical motors, and a power module for storing energy in a battery energy storage module, for generating energy using at least one energy converter module, and for controlling power flows within the electrical vehicle in response to driving commands provided from a user, wherein the power module is configured to control power delivered to and received from the one or more motors,
wherein:
the at least one energy converter module is configured to bifurcate photons into corresponding electrons and positrons, to configure the electrons and positrons to undergo spontaneous mutual acceleration to provide corresponding accelerated electrons and positrons, and to harvest energy of the accelerated electrons and positrons to provide power to operate the electrical vehicle.

2. The electrical vehicle of claim 1, wherein the format of power includes: direct current (d.c.), alternating current (a.c.).

3. The electrical vehicle of claim 2, wherein the energy converter module is configured for converting photons into electrical energy, wherein the energy converter module is implemented as an integrated circuit in which the photons propagate in a coherent manner, wherein the energy converter module includes a configuration of waveguides and electrodes that are configured to receive the photons, at least partially bifurcate the photons into their respective electrons and positrons, configure the at least partially bifurcated electrons and positrons so that they mutually accelerate to provide accelerated electrons and positrons, and harvest the accelerated electrons and positrons to generate the electrical energy.

4. The electrical vehicle of claim 3, wherein the integrated circuit is implemented as a Lithium Niobate photonic integrated circuit or a Lithium-Niobate-On-Insulator photonic integrated circuit.

5. The electrical vehicle of claim 4, wherein the waveguides are fabricated from an optically non-linear material that is configured to exhibit in use a non-linear optical characteristic.

6. The electrical vehicle of claim 5, wherein the waveguides are implemented in an array of mutually parallel elongate waveguides.

7. The electrical vehicle of claim 6, wherein the energy converter includes a biasing and acceleration region therein, wherein the biasing and acceleration region is configured to apply an electric field to the positrons and electrons to cause them to be configured to mutually accelerate to gain energy, wherein the electric field is orientated with its electric field vector substantially parallel to elongate axes of the waveguides along which the electrons and positrons propagate.

8. A method for operating an electrical vehicle, comprising:
configuring the electrical vehicle for power flows to occur therein when in operation; and
configuring the electrical vehicle to include an energy converter module for delivering power to the electrical vehicle, wherein the energy converter module is configured to bifurcate photons into corresponding electrons and positrons, to configure the electrons and positrons to undergo spontaneous mutual acceleration to provide corresponding accelerated electrons and positrons, and to harvest energy of the accelerated electrons and positrons to provide power to operate the electrical vehicle.

9. The method of claim 8, further comprising configuring the electrical vehicle to receive power from a utility power grid to contribute to the power flows.

10. The method of claim 8, further comprising configuring the electrical vehicle to deliver power to the utility power grid derived from the power flows within the electrical vehicle.

11. One or more hardware-based non-transitory memory devices storing computer executable instructions which, when executed by one or more processors disposed in a computing device, cause the computing device to:
configure an electrical vehicle for power flows to occur therein when in operation; and
configure the electrical vehicle to include an energy converter module for delivering power to the electrical vehicle, wherein the energy converter module is configured to bifurcate photons into corresponding electrons and positrons, to configure the electrons and positrons to undergo spontaneous mutual acceleration to provide corresponding accelerated electrons and positrons, and to harvest energy of the accelerated electrons and positrons to provide power to operate the electrical vehicle.

12. The one or more hardware-based non-transitory memory devices of claim 11, wherein the executed instructions further cause the computing device to configure the electrical vehicle to receive power from a utility power grid to contribute to the power flows.

13. The one or more hardware-based non-transitory memory devices of claim 11, wherein the executed instructions further cause the computing device to configure the electrical vehicle to deliver power to the utility power grid derived from the power flows within the electrical vehicle.
